(19) United States
(12) Patent Application Publication
(10) Pub. No.: US 2014/0201849 A1
(43) Pub. Date: Jul. 17, 2014

(54) SECURING EMBEDDED CONTENT IN A DISPLAY FRAME WITH PLAYER TRACKING SYSTEM INTEGRATION

(71) Applicant: WMS GAMING, INC., Waukegan, IL (US)

(72) Inventor: Edward Q. Earley, Chicago, IL (US)

(73) Assignee: WMS GAMING, INC., Waukegan, IL (US)

(21) Appl. No.: 13/787,043

(22) Filed: Mar. 6, 2013

Related U.S. Application Data
(60) Provisional application No. 61/753,093, filed on Jan. 16, 2013.

(51) Int. Cl. H04L 29/06

(52) U.S. Cl. CPC H04L 63/10
USPC 726/28

(57) ABSTRACT

Systems and methods are described for receiving restricted content in an embedded frame of a display. A first content server provides content for presentation to a client. In response to a request to present restricted content stored on a second server, the first server creates a URL query string including user credential data for authorizing the restricted content. The first server adds one or more hidden parameters to the URL query string and creates a signature based on the URL query string. The first server adds the signature to the URL query string to form a final query string and sends the final query string to a second content server in a request for the restricted content. The first server receives the restricted content and presents the restricted content in the embedded frame.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2013, WMS Gaming, Inc.

### FIELD

Embodiments of the inventive subject matter relate generally securing embedded content, and more particularly to securing embedded content using player tracking system information.

### BACKGROUND

Online games such as online skill games, simulation games, wagering games and the like have become more and more popular over the years. Online games are typically server based games that are provided to online gaming clients. Generally, the popularity of a game depends on the likelihood (or perceived likelihood) of winning the game and the intrinsic entertainment value of the game relative to other available gaming options. Players are likely to be attracted to the most entertaining and exciting games. Shrewd operators consequently strive to employ the most entertaining and exciting games, features, and enhancements available because such games attract frequent play and hence increase profitability to the operator or provider of the game. Therefore, there is a continuing need for game developers to continuously develop new games and gaming enhancements that will attract frequent play.

It is often desirable for game developers to provide online games or other content along with content from another source. In such cases, the online game or content may be embedded with the content from another source. As an example, a casino may wish to embed an online game provided by a third party vendor into the casino's own web site. The online game may be restricted, therefore requiring user authentication before the online game may be played. It is often the case that the user authentication credentials are exchanged between a first content provider and the online game provider. Such exchanges may be subject to attacks from malicious parties. For example, a man-in-the-middle attack, direct manipulation attack, or replay attack may be used to provide a malicious party with unauthorized access to online game content that is embedded with content from another source.

### BRIEF DESCRIPTION OF THE FIGURES

Embodiments of the invention are illustrated in the Figures of the accompanying drawings in which:

FIG. 1 is a block diagram of a system for securing embedded content with player tracking integration.

FIG. 2 is a flowchart of a method including client side operations for securing embedded content with player tracking integration.

FIG. 3 is a flowchart illustrating a method including server side operations for securing embedded content with player tracking integration.

FIG. 4 is a sequence diagram illustrating a method for securing embedded content according to embodiments.

FIG. 5 is a block diagram of an example embodiment of a computer system upon which embodiments of the inventive subject matter can execute.

### DESCRIPTION OF THE EMBODIMENTS

This description of the embodiments is divided into five sections. The first section provides an introduction to embodiments of the invention, while the second section describes example system architectures. The third section describes example operations performed by some embodiments and the fourth section describes example computing systems that may be used in the implementation of embodiments. The fifth section presents some general comments.

### Introduction

This section provides an introduction to some embodiments of the invention. Generally speaking, the embodiments provide a way for restricted content from one content provider to be embedded in a display frame for a display having content controlled by a second provider. The restricted content is typically content that requires some level of authorization or authentication before the content may be received. In some embodiments, a player tracking system identification is used to provide credentials as part of the authorization or authentication.

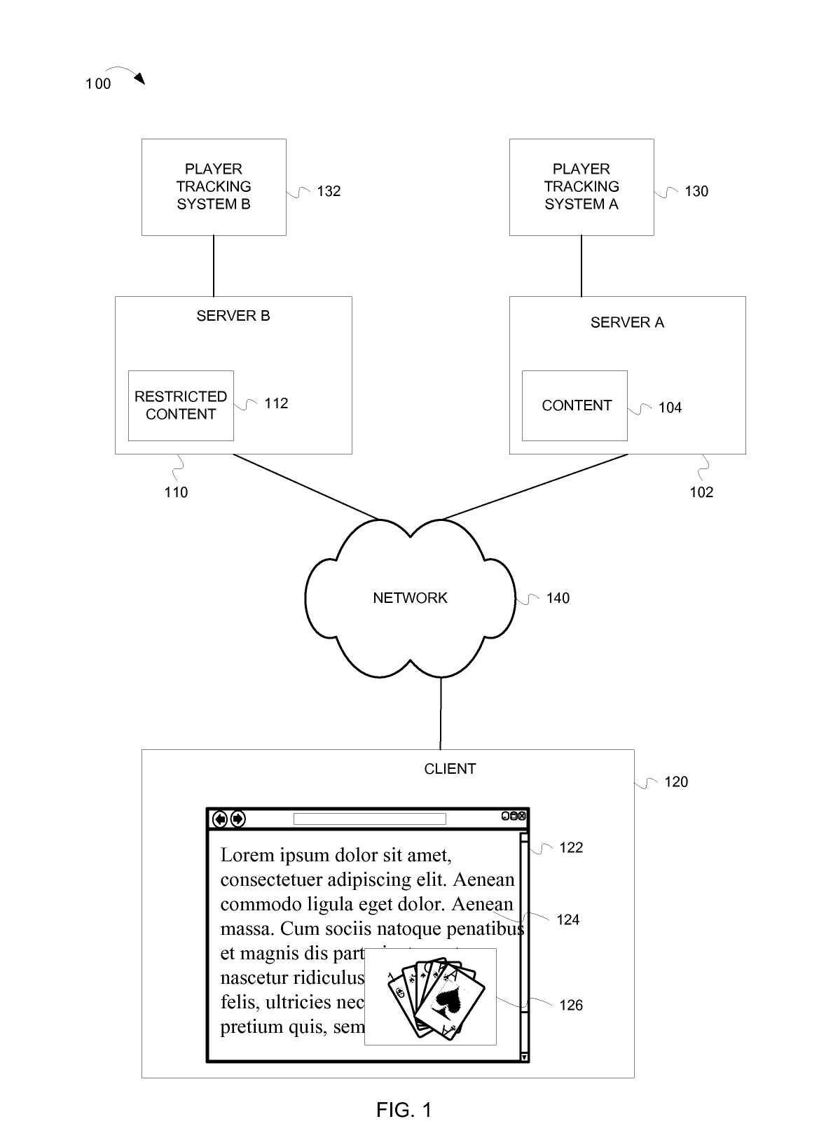

FIG. 1 is a block diagram of a system 100 for securing embedded content with player tracking integration. In some embodiments, system 100 includes a first content server A 102, a second content server B 110, and a user client 120. Server A 102, Server B 110 and user client 120 may be communicably coupled using network 140. Network 140 may be any combination of wired and wireless networks. In some embodiments, network 140 is the Internet.

Server A 102 provides content 104 to clients such as user client 120. In some embodiments server A 102 may be a web server providing web based content. The content may be any type of content, including web pages, audio, video, online games, news, sports, weather, events or other content. Content 104 may require user authentication prior to the content being provided to the user. In some embodiments, content 104 may be a web page for a casino. For example, the web page may be a web page providing access to users registered on the casino's player tracking system, player tracking system A 130.

Server B 110 provides restricted content 112 to authorized users. Server B 110 may be a web server providing web based content. Server B may also be configured as a web services provider. In some embodiments, a user must provide authentication credentials before being allowed access to restricted content 112. The restricted content may be any type of content, including online games, audio content, video content, data such as news, sports, financial or weather data, player tracking data etc. The embodiments are not limited to any particular type of restricted content.

User client 120 receives content for display to a user, for example as a web page 122. User client 120 may display content from multiple sources on web page 122. For example, content 104 may be displayed in frame 114, while restricted content 110 may be displayed as an embedded frame 126 on web page 122. In the example illustrated in FIG. 1, restricted content 112 is an online poker game with a user interface for the game provided in frame 126. Those of skill in the art having the benefit of the disclosure will appreciate that other types of restricted content could be provided in frame 126. The user may provide authentication credentials such as a user name, password, player tracking id etc. through a user interface provided either in frame 124 or embedded frame 126.

In some embodiments, embedded frame 126 may be displayed as an Iframe. Generally speaking, frames allow a visual HTML Browser window to be split into segments (frames), each of which can show a different document. This can lower bandwidth use, as repeating parts of a layout can be used in one frame, while variable content is displayed in another. An Iframe (inline frame) is a special type of frame element which can be the “target” frame for links defined by other elements and it can be selected by the user agent as the focus for printing, viewing its source, etc. Thus in some embodiments, restricted content 112 is displayed as an Iframe, allowing one party (e.g., server A 102) to provide content displayed in one frame (e.g., frame 122) while another party (e.g., server 110) can manage restricted content 112 provided in frame 126.

System 100 may include player tracking system A 130. In some embodiments, player tracking system A 130 is associated with server A 102. Generally speaking, a player tracking system is used to track or log a user's activities in a casino or on a casino's web site. In exchange for allowing such tracking to take place, the user may be provided incentives such as wagering game enhancements (special features, free spins etc.) and discounted food, entertainment, lodging etc.

System 100 may optionally include player tracking system B 132. In some embodiments, player tracking system B 132 is associated with server B 110. Servers A and B and player tracking systems A and B may be associated with different operators. For example, server A and player tracking system A may be associated with a particular casino operator, while server B and player tracking system B may be associated with a wagering game vendor. In some embodiments, there may be some cooperation or partnership between the operators of servers A and B and player tracking systems A and B. For example, a user may have player tracking accounts on both player tracking systems A and B. The player tracking systems may include the capability to map between player tracking identifiers for the user maintained on player tracking systems A and B. For example, player tracking system A may have the ability to map a player tracking user ID from player tracking system B to a user ID on player tracking system A and vice versa.

Although FIG. 1 describes some embodiments, the following sections describe many other features and embodiments, and will provide further details on the operation of system 100.

### Example Operations

This section describes operations associated with some embodiments of the invention. In the discussion below, the flow diagrams will be described with reference to the block diagrams presented above. However, in some embodiments, the operations can be performed by logic not described in the block diagrams.

In certain embodiments, the operations can be performed by executing instructions residing on machine-readable media (e.g., software), while in other embodiments, the operations can be performed by hardware and/or other logic (e.g., firmware). In some embodiments, the operations can be performed in series, while in other embodiments, one or more of the operations can be performed in parallel. Moreover, some embodiments can perform less than all the operations shown in any flow diagram.

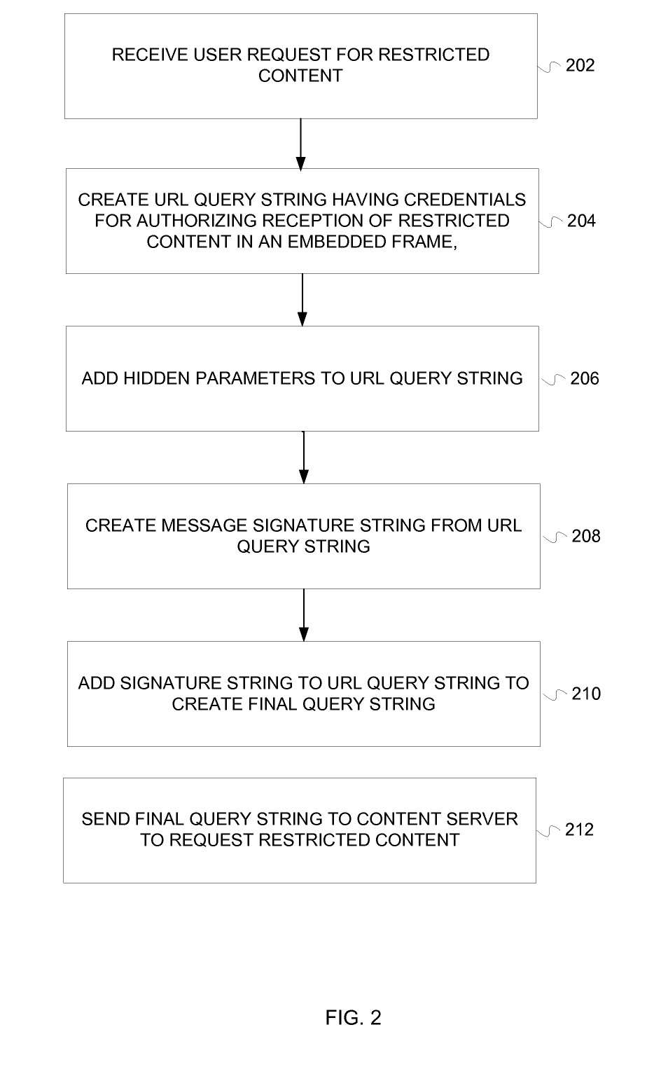

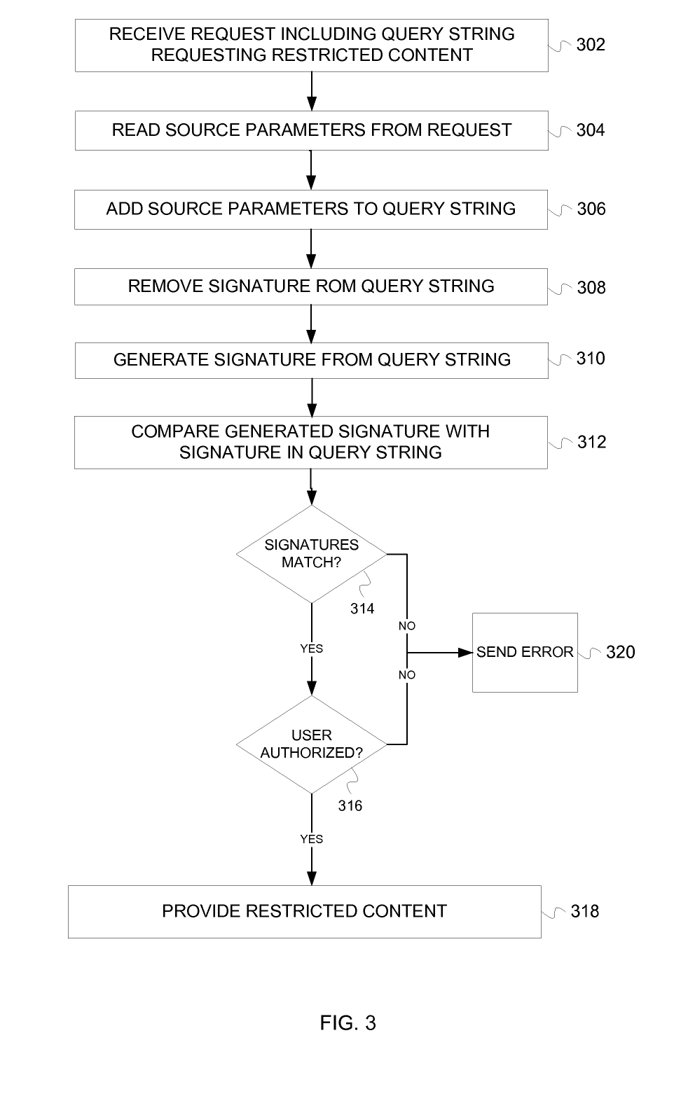

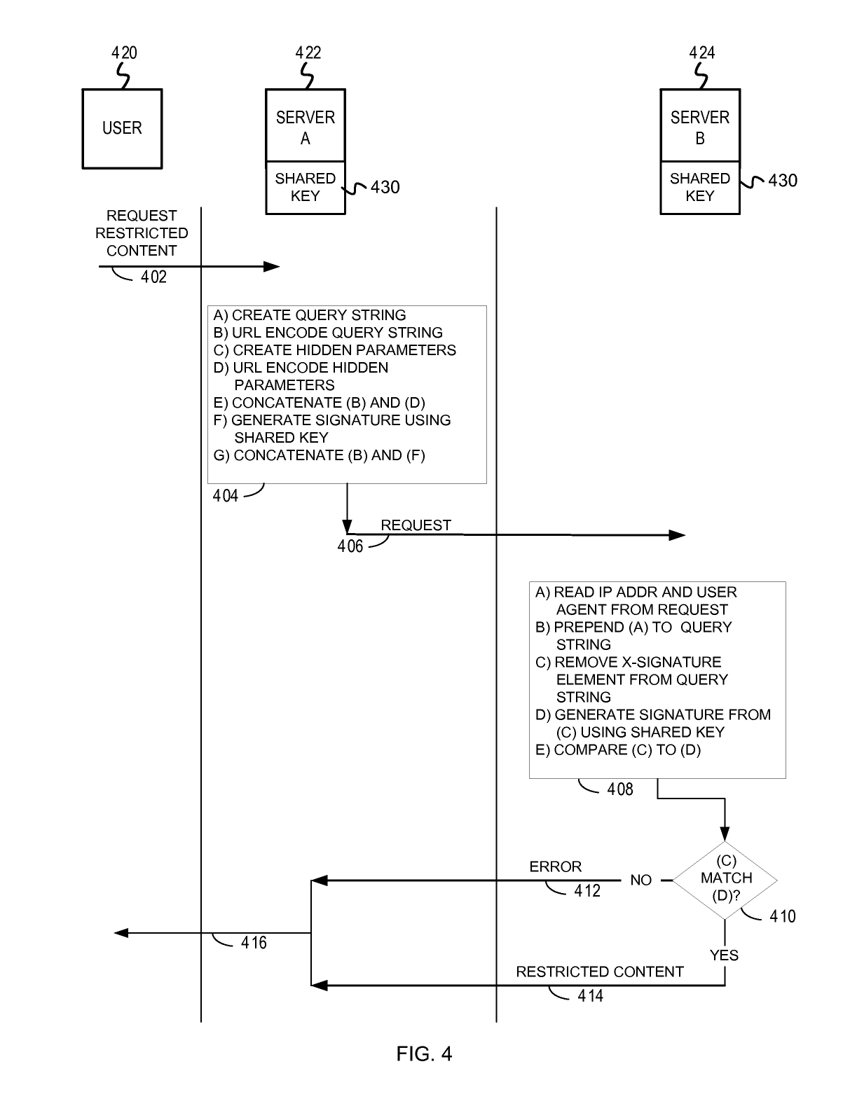

The section will discuss FIGS. 2-4. The discussion of FIG. 2 will describe client side operations for securing restricted content integrated with a player tracking system. The discussion of FIG. 3 will describe server side operations for securing restricted content integrated with a player tracking system. The discussion of FIG. 4 will provide an example sequence diagram illustrating the methods described in FIGS. 2 and 3. The term “server” is used from the point of view of a server hosting restricted content 112 (e.g., server B 110). Thus while operations may be described as client side operations, the client will often in fact be another server using the services provided by the server hosting the restricted client.

FIG. 2 is a flowchart of a method 200 including client side operations for securing embedded content with player tracking integration. Method 200 begins at block 202 with receiving a user request for restricted content. For example, a user may be provided a web browser page that includes links or other user interface elements that allow the user to request the restricted content. As noted above, the restricted content may be an online game, video, audio, financial data, sports data, weather data, email etc. The request may be received by a first server (e.g., server A 102, FIG. 1).

At block 204 the receiving server creates an initial URL (Uniform Resource Locator) query string that includes the credentials to be used to authorize receiving the restricted content. In some embodiments, the credentials may be encrypted user credentials for a first player tracking system (e.g., player tracking system A 130, FIG. 1). The initial URL query string may also include the date of the request. In some embodiments, the URL query string is URL encoded. That is, characters in a parameter that may have special meaning in a URL string are replaced with text that will avoid special treatment by a query string parser. For example, a white space character in a string may be replaced by “%20”, an “=” character may be replaced by “%3D” and other characters may be replaced.

At block 206, the receiving server adds hidden parameters to the URL query string created at block 204. Hidden parameters comprise parameters that are used in a later signature generation operation, but are not passed as part of the URL query string. In some embodiments, the hidden parameters may include the IP address of the client that will make the request for restricted content, and the user agent (browser type) of the browser that will interpret the response. In some embodiments, the hidden parameters may be URL encoded. At block 208, a message signature is created for the URL query string created at block 204 and modified at block 206. In some embodiments, the signature is an HMAC (Hash-based Message Authentication Code) signature created from the URL string. In particular embodiments, the receiving server creates an RFC 2104 compliant HMAC signature from the URL query string. In some embodiments, the signature is created using a shared key that is shared between the receiving server (e.g., server A 102) and the restricted content server (e.g., server B 110).

At block 210, the signature created at block 208 is appended to the URL query string to create a final query string.

At block 212 the final query string is sent from the receiving server to the server hosting the restricted content. The server hosting the restricted content receives the request including the final version of the query string and processes the request as described in FIG. 3.

FIG. 3 is a flowchart illustrating a method 300 including server side operations for securing embedded content with player tracking integration. The method begins at block 302 with a restricted content server (e.g., server B 110, FIG. 1) receiving a request for the restricted content, where the request includes the query string created using method 200 described above.

At block 304 the restricted content server reads the source parameters from the request. In some embodiments, the source parameters include the IP address of the request source and the user agent (e.g., web browser type). In some embodiments, the source parameters are URL encoded.

At block 306, the source parameters are prepended onto the query string received with the request.

At block 308, the signature parameter is removed from the query string.

At block 310, a signature is generated for the query string as modified by blocks 306 and 308. In some embodiments, the signature is an HMAC signature and is created using the shared key that is shared between the server that created the request (e.g., server A 102) and the restricted content server (e.g., server B 110).

At block 312, the generated signature is compared to the signature received in the query string (and removed from the query string at block 308). At decision block 314, a determination is made of the comparison resulted in a match between the signature received in the request and the signature generated at block 310.

If the generated signature and the received signature match, then at block 316, user credentials received in the request string are processed to determine if the user is authorized to receive the restricted content. If the user is authorized, then at block 318, the restricted content is sent to the requesting server for presentation to the user. The user credentials may comprise user credentials for a player tracking system. In some embodiments, the user credentials may be for a first player tracking system associated with a first content provider. The user credentials may be mapped to user credentials for a second player tracking system associated with the restricted content.

If the generated signature does not match the signature received in the query string or if the user is not authorized to receive the restricted content, then at block 320 an error is returned to the requesting server.

FIG. 4 is a sequence diagram 400 illustrating a method for securing embedded content according to embodiments. The sequence diagram illustrated in FIG. 4 provides an example of the operation of methods 200 and 300 described above, and uses example parameters to further illustrate and provide further details on the inventive subject matter. Those of skill in the art having the benefit of the disclosure will appreciate that the inventive subject matter is not limited to the example parameters illustrated in the example described in FIG. 4.

In the example sequence of operations described below, operations between a user client 420, a first server A 422 and a second server B 424 are described. Server A 422 and server B 424 are configured to share a key 430 that is used to create signatures. The shared key may be provided to server A 422 and server B 424 using conventional shared key distribution methods now known in the art or developed in the future.

The sequence diagram begins at operation 402 with a user requesting restricted content via a user interface provided on user client 420. The request may occur after the user has logged into server 422 providing user authentication credentials. In some embodiments, the user authentication credentials may include a player tracking ID.

At operation 404, server A 422 creates a server based request for the restricted contact. In general, the suboperations A-G of operation 404 comprise a particular implementation of method 200 (FIG. 2) described above. At operation 404A, server A 422 creates a query string. For the purposes of the example, server A 422 creates a query string that includes the date and time of the request (x-date parameter label) and an encrypted player tracking ID (x-identity label) of the user making the request. For the purposes of the example, the initial query string is:
x-date=20120927T140971Z&
x-identity=20b92c5b4ac55cdceb889574a1e85590ca243956

At operation 402B, server A 422 URL encodes the initial query string to from the query string:
x-date%3D201209271T140971Z%26
x-identity%3D20b92c5b4ac55cdceb889574a1e85590ca243956
Note that URL encoding has replaced the “=” character with the “%3D” string.

At operation 402C, server A 422 creates a hidden parameters string. In some embodiments, the hidden parameters string includes an IP address (x-ip-addr) and a user agent (x-user-agent). For the purposes of the example, the hidden parameters are:
x-ip-addr=127001&
x-user-agent=Mozilla/5.0 (Windows NT 5.1)
AppleWebKit/537.4 (KHTML, like Gecko)
Chrome/22.0.1229.79 Safari/537.4

At operation 402D, server A 422 URL encodes the hidden parameters string to create the string:
x-ip-addr%3D127001%26
x-user-agent%3DMozilla%2F5.0%20(Windows%20NT%205.1)
%20AppleWebKit%2F537.4%20(KHTML%2C%20like%20Gecko)
%20Chrome%2F22.0.1229.79%20Safari%2F537.4

At operation 402E, server A 422 concatenates the initial query string from operation 402B and the hidden parameters created at operation 402D to create the query string:
x-ip-addr%3D127001%26
x-user-agent%3DMozilla%2F5.0%20(Windows%20NT%205.1)
%20AppleWebKit%2F537.4%20(KHTML%2C%20like%20Gecko)
%20Chrome%2F22.0.1229.79%20Safari%2F537.4%26
x-date%3D201209271T140971Z%26
x-identity%3D20b92c5b4ac55cdceb889574a1e85590ca243956

At operation 402F, server A 422 creates an HMAC signature for the string created at operation 402E. The resulting signature is:
PtaLJhjKLkBB9hR9TP47aPJw1F4=

At operation 402G, server A 422 adds the signature to the query string created at operation 402B using an “x-signature” label, resulting in the example query string:
x-date=201209271T140971Z&
x-identity=20b92c5b4ac55cdceb889574a1e85590ca243956&
x-signature=PtaLJhjKLkBB9hR9TP47aPJw1F4=

At operation 406, a request for the restricted content is sent to the server hosting the restricted content, server B 424. The request includes the final query string produced at operation 402G.

At operation 408, server B 424 parses the request, including the query string to determine if the restricted content identified in the request will be provided in response to the request. In general, the suboperations A-E of operation 408 404 comprise a particular implementation of method 300 (FIG. 3) described above.

At operation 408A, server B 424 reads the IP address and user agent parameters from the request and creates a string representing the parameters. In some embodiments, the string has the form:
x-ip-addr%3D127001%26
x-user-agent%3DMozilla%2F5.0%20(Windows%20NT%205.1)
%20AppleWebKit%2F537.4%20(KHTML%2C%20like%20Gecko)
%20Chrome%2F22.0.1229.79%20Safari%2F537.4

At operation 408B, server B 424 prepends the parameter string from operation 408A to the query string to create the string:
x-ip-addr%3D127001%26
x-user-agent%3DMozilla%2F5.0%20(Windows%20NT%205.1)
%20AppleWebKit%2F537.4%20(KHTML%2C%20like%20Gecko)
%20Chrome%2F22.0.1229.79%20Safari%2F537.4%26
x-date=201209271T140971Z&
x-identity=20b92c5b4ac55cdceb889574a1e85590ca243956&
x-signature=PtaLJhjKLkBB9hR9TP47aPJw1F4=

At operation 408C, server B 424 removes the signature from the string created at block 408B, resulting in the string:
x-ip-addr%3D127001%26
x-user-agent%3DMozilla%2F5.0%20(Windows%20NT%205.1)
%20AppleWebKit%2F537.4%20(KHTML%2C%20like%20Gecko)
%20Chrome%2F22.0.1229.79%20Safari%2F537.4%26
x-date=2012092711140971Z&
x-identity=20b92c5b4ac55cdceb889574a1e85590ca243956&

At operation 408D, server B 424 generates an HMAC signature for the string created at operation 408C using the shared key shared between server A 422 and server B 424.

At operation 408E, server B 424 compares the signature generated at operation 408D with the signature parameter received in the query string (e.g., “PtaLJhjKLkBB9hR9TP47aPJw1F4=”). At operation 410, if the signatures do not match, then at operation 412, an error is returned to the requesting server. In some embodiments, an HTML 417 error is returned along with an error page. Alternatively, if the signatures do match, then at operation 414, the restricted content is provided to server 422A.

At operation 416, server A 422 relays either the error from operation 412 or the restricted content from operation 414 to the user client 420.

It should be noted that other parameters from the query string may be checked for validity. For example, the timestamp (e.g., the x-date parameter) may be checked against the current time to determine if the request is stale. In some embodiments, a request that occurs more than five minutes after the timestamp may be considered stale and will result in an error being returned to the requestor.

Additionally, the user agent of the requesting client may be checked for a match with the user agent in the query string. Further, the IP address of the requesting client should match the IP address parameter (e.g., the x-ip-addr parameter) provided in the query string.

Those of skill in the art having the benefit of the disclosure will appreciate that other parameters may be included in the request or in the query string provided with the request and that such parameters may checked to aid in insuring that the request is valid.

### Example Computing Systems

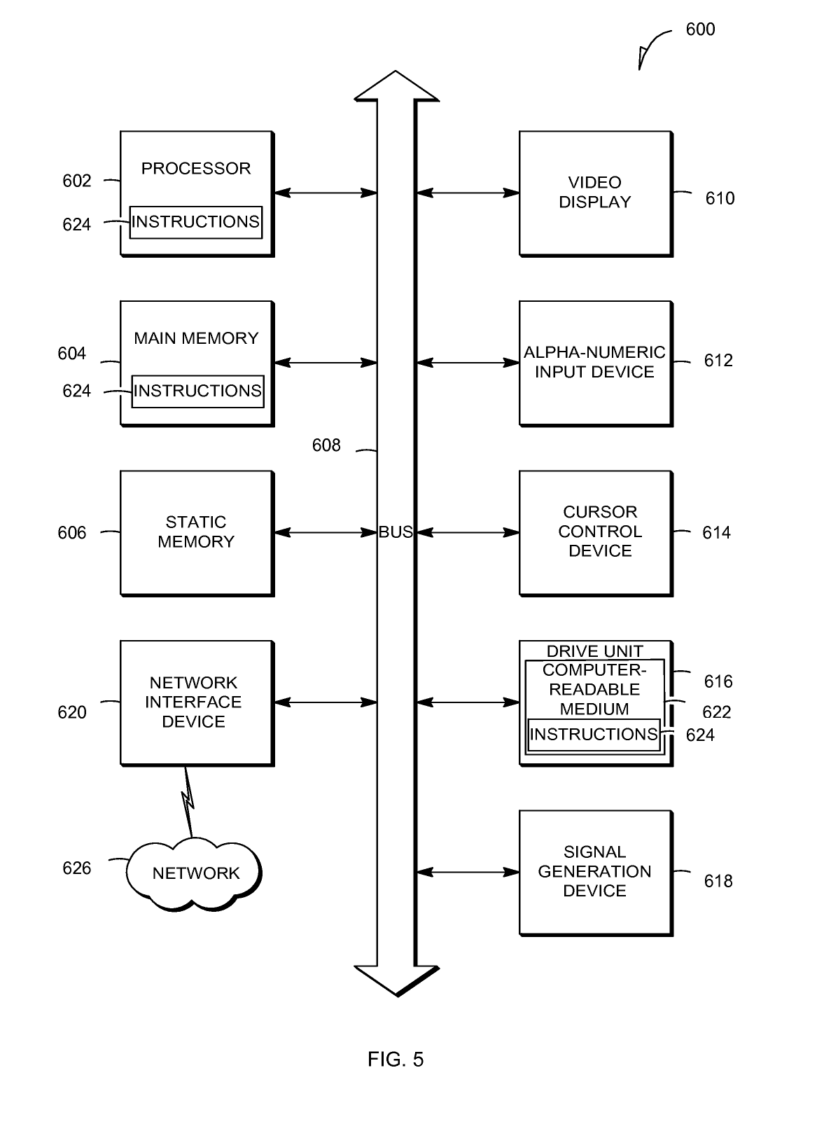

FIG. 5 is a block diagram of an example embodiment of a computer system 500 upon which embodiments of the inventive subject matter can execute. The description of FIG. 5 is intended to provide a brief, general description of suitable computer hardware and a suitable computing environment in conjunction with which the invention may be implemented. In some embodiments, the invention is described in the general context of computer-executable instructions, such as program modules, being executed by a computer. Generally, program modules include routines, programs, objects, components, data structures, etc., that perform particular tasks or implement particular abstract data types.

As noted above, the system as disclosed herein can be spread across many physical hosts. Therefore, many systems and sub-systems of FIG. 5 can be involved in implementing the inventive subject matter disclosed herein.

Moreover, those skilled in the art will appreciate that the inventive subject matter may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 5, a hardware and operating environment is provided that is applicable to both servers and/or remote clients.

With reference to FIG. 5, an example embodiment extends to a machine in the example form of a computer system 500 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. Further, while only a single machine is illustrated, the term “machine” shall also be taken to include any collection of machines that individually or jointly execute a set (or multiple sets) of instructions to perform any one or more of the methodologies discussed herein.

The example computer system 500 may include a processor 502 (e.g., a central processing unit (CPU), a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). In example embodiments, the computer system 500 also includes one or more of an alpha-numeric input device 512 (e.g., a keyboard), a user interface (UI) navigation device or cursor control device 514 (e.g., a mouse), a disk drive unit 516, a signal generation device 518 (e.g., a speaker), and a network interface device 520.

The disk drive unit 516 includes a machine-readable medium 522 on which is stored one or more sets of instructions 524 and data structures (e.g., software instructions) embodying or used by any one or more of the methodologies or functions described herein. The instructions 524 may also reside, completely or at least partially, within the main memory 504 or within the processor 502 during execution thereof by the computer system 500, the main memory 504 and the processor 502 also constituting machine-readable media.

While the machine-readable medium 522 is shown in an example embodiment to be a single medium, the term “machine-readable medium” may include a single medium or multiple media (e.g., a centralized or distributed database, or associated caches and servers) that store the one or more instructions. The term “machine-readable medium” shall also be taken to include any medium that is capable of storing, encoding, or carrying instructions for execution by the machine and that cause the machine to perform any one or more of the methodologies of embodiments of the inventive subject matter, or that is capable of storing, encoding, or carrying data structures used by or associated with such instructions. Machine-readable media may include machine-readable storage media and machine-readable signal media. The term “machine-readable storage medium” shall accordingly be taken to include, but not be limited to, solid-state memories and optical and magnetic media that can store information in a non-transitory manner, i.e., media that is able to store information for a period of time, however brief. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 524 may further be transmitted or received over a communications network 526 using a transmission medium via the network interface device 520 and utilizing any one of a number of well-known transfer protocols (e.g., FTP, HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “machine-readable transmission medium” shall be taken to include any intangible medium that is capable of storing, encoding, or carrying instructions for execution by the machine, and includes digital or analog communications signals or other intangible medium to facilitate communication of such software. Such communications signals may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

1. A method comprising:
creating, by one or more processors, a URL (Uniform Resource Locator) query string, the URL query string stored in a memory coupled to the one or more processors and including user credential data and one or more parameters, the user credential data for authorizing the user to receive restricted content in an embedded frame of a user interface;
adding one or more hidden parameters to the URL query string;
creating a signature based on the URL query string;
adding the signature to the URL query string to form a final query string; and
sending the final query string to a content server in a request for the restricted content.

2. The method of claim 1, wherein adding one or more hidden parameters includes adding one or more of a client IP address, client user agent or a timestamp.

3. The method of claim 1, wherein creating the signature includes creating an HMAC (Hash-based Message Authentication Code) signature.

4. The method of claim 1, wherein receiving user credential data includes receiving player tracking credential data.

5. The method of claim 1, wherein creating the signature includes creating the signature using a key shared with a server storing the restricted content.

6. A method comprising:
receiving, into a memory coupled to one or more processors, a request for authorizing restricted content to be presented in an embedded frame of a user interface, the request including a query string including a first signature;
adding, by the one or more processors, one or more parameters from the request to the query string;
removing the first signature from the query string;
generating a second signature from the query string;
comparing the first signature to the second signature; and
in response to determining that the first signature matches the second signature, providing the restricted content.

7. The method of claim 6, wherein adding one or more parameters includes adding one or more of a client IP address or a client user agent obtained from the request.

8. The method of claim 6, wherein generating the second signature includes generating an HMAC signature.

9. The method of claim 6, wherein creating the signature includes creating the signature using a key shared with a server requesting the restricted content.

10. A system comprising:
one or more processors; and
at least one memory device storing instructions associated with a first content server, that when executed by the one or more processors, cause the system to:
create a URL query string, the URL query string including user credential data and one or more parameters, the user credential data for authorizing the user to receive restricted content in an embedded frame of a user interface,
add one or more hidden parameters to the URL query string,
create a signature based on the URL query string,
add the signature to the URL query string to form a final query string, and
send the final query string to a second content server in a request for the restricted content.

11. The system of claim 10, wherein the one or more hidden parameters include one or more of a client IP address, client user agent or a timestamp.

12. The system of claim 10, wherein the signature comprises an HMAC signature string.

13. The system of claim 10, wherein the user credential data comprises player tracking credential data.

14. The system of claim 10, wherein the first content server creates the signature string using a key shared with the second content server.

15. A system comprising:
one or more processors; and
at least one memory device storing instructions associated with a first content server storing restricted content, the instructions, when executed by the one or more processors, cause the system to:
receive a request for authorizing the restricted content to be presented in an embedded frame of a user interface, the request including a query string including a first signature;
add one or more parameters from the request to the query string;
remove the first signature from the query string;
generate a second signature from the query string;
compare the first signature to the second signature; and
in response to a determination that the first signature matches the second signature, provide the restricted content.

16. The system of claim 15, wherein adding one or more parameters includes adding one or more of a client IP address or a client user agent obtained from the request.

17. The system of claim 15, wherein the first signature and the second signature comprise HMAC signatures.

18. The system of claim 15, wherein the second signature string is generated using a key shared with the first server.

19. A machine-readable storage medium having stored thereon machine executable instructions for causing one or more processors to perform operations comprising:
creating a URL (Uniform Resource Locator) query string, the URL query string including user credential data and one or more parameters, the user credential data for authorizing the user to receive restricted content in an embedded frame of a user interface;
adding one or more hidden parameters to the URL query string;
creating a signature based on the URL query string;
adding the signature to the URL query string to form a final query string; and
sending the final query string to a content server in a request for the restricted content.

20. The machine-readable storage medium of claim 19, wherein adding one or more hidden parameters includes adding one or more of a client IP address, client user agent or a timestamp.

21. The machine-readable storage medium of claim 19, wherein creating the signature includes creating an HMAC (Hash-based Message Authentication Code) signature.

22. The machine-readable storage medium of claim 19, wherein receiving user credential data includes receiving player tracking credential data.

23. The machine-readable storage medium of claim 19, wherein creating the signature includes creating the signature using a key shared with a server storing the restricted content.

24. A machine-readable storage medium having stored thereon machine executable instructions for causing one or more processors to perform operations comprising:
receiving a request for authorizing restricted content to be presented in an embedded frame of a user interface, the request including a query string including a first signature;
adding one or more parameters from the request to the query string;
removing the first signature from the query string;
generating a second signature from the query string;
comparing the first signature to the second signature; and
in response to determining that the first signature matches the second signature, providing the restricted content.

25. The machine-readable storage medium of claim 24, wherein adding one or more parameters includes adding one or more of a client IP address or a client user agent obtained from the request.

26. The machine-readable storage medium of claim 24, wherein generating the second signature includes generating an HMAC signature.

27. The machine-readable storage medium of claim 24, wherein creating the signature includes creating the signature using a key shared with a server requesting the restricted content.

28. The machine-readable storage medium of claim 24, wherein the query string includes user credentials for a first player tracking system, and wherein the operations further comprise mapping the user credentials for the first player tracking system to user credentials for a second player tracking system.
